(19) United States
(12) Patent Application Publication
(10) Pub. No.: US 2019/0351351 A1
(43) Pub. Date: Nov. 21, 2019

(54) CAP ARRANGEMENT FOR BOTTLE

(71) Applicant: Tvisha SINGH, Fremont, CA (US)

(72) Inventor: Tvisha SINGH, Fremont, CA (US)

(21) Appl. No.: 15/981,791

(22) Filed: May 16, 2018

(51) Int. Cl. B01D 35/04; B65D 41/04; B65D 47/06; B65D 51/18; B01D 29/05

(52) U.S. Cl. CPC B01D 35/04; B65D 41/0442; B65D 47/065; B65D 51/18; B01D 2201/342; B65D 2251/0078; B65D 2251/0018; B01D 2201/167; B01D 29/05

(57) ABSTRACT

Disclosed is a cap arrangement for a bottle. The cap arrangement comprises a cap having a flat portion, and a hollow portion having a first end and an opposite second end. The hollow portion extends vertically from a periphery of the flat portion. One or more internal threads are arranged on the second end, of the hollow portion, away from the first end. The cap arrangement further comprises a mouth portion of the bottle, wherein the mouth portion comprises one or more complementary external threads arranged away from an opening of the mouth portion of the bottle. The one or more external threads and the one or more internal threads allow threadable engagement between the cap and the mouth portion away from the opening of the bottle.

### TECHNICAL FIELD

The present disclosure relates generally to containers, such as bottles, for holding edible liquid, more particularly to, a cap arrangement for a bottle.

### BACKGROUND

Most of the edible things are nowadays sold in a packaged form. For example, an edible liquid such as water, juice, aerated drinks, edible-oil, sauce and so forth are readily sold in a packaged form. One such packaged form includes plastic bottles containing such edible liquid.

However, recent studies have shown that bottled (or packed) edible liquid suffer from various problems. For example, 90-98% of bottled water includes plastic particles in it. Further, a size of such plastic particles ranges from 6.5-100 μm (micrometer). Moreover, a majority of plastic particles found in the water are same as that of plastic composition of a cap or a mouth portion of the bottle. In an example, the plastic particles found in the bottle may be generated due to a threadable engagement between the cap and the mouth portion of the bottle. For example, upon repeatedly opening and closing the cap of the bottle causes a rubbing action between threads of the cap and mouth portion which may generate such plastic particles. Therefore, while drinking water from such bottle may cause a person to consume the plastic particles along with the water, which is medically not advisable.

In light of the foregoing discussion, there exists a need to overcome the aforementioned drawbacks associated with bottles containing edible liquid.

### SUMMARY

Various embodiments of the present disclosure provide a cap arrangement for a bottle.

In an embodiment, a cap arrangement for a bottle is disclosed. The cap arrangement comprises a cap having a flat portion and a hollow portion. The hallow portion has a first end and an opposite second end. The hollow portion extends vertically from a periphery of the flat portion. One or more internal threads are arranged on the second end, of the hollow portion, away from the first end. The cap arrangement further comprises a mouth portion of the bottle. The mouth portion comprises one or more complementary external threads arranged away from an opening of the mouth portion of the bottle. The one or more external threads and the one or more internal threads allow threadable engagement between the cap and the mouth portion away from the opening of the bottle.

In another embodiment, a cap arrangement for a bottle is disclosed. The cap arrangement comprises a cap. The cap has a flat portion, a filter member, a hollow portion and a coupling mechanism. The flat portion has a central opening, the filter member is arranged on the flat portion for closing the central opening. The hollow portion has a first end and an opposite second end, the hollow portion extends vertically from a periphery of the flat portion. The coupling mechanism is operable to engage the cap to a mouth portion of the bottle to close an opening of the bottle. The cap arrangement further comprises a cap-cover configured to enclose the cap from outside.

In yet another embodiment, a cap arrangement for a bottle is disclosed. The cap arrangement comprises a cap having a flat portion, a spout arranged on the flat portion, and a hollow portion. The spout comprises an opening and configured to attain an open position and a close position with respect to the flat portion. The hollow portion extending vertically from a periphery of the flat portion, and one or more internal threads are arranged on the hollow portion. The one or more internal threads of the cap are operable to engage with one or more complementary external threads arranged on a mouth portion of the bottle. The cap arrangement further comprises a filter member arranged on the spout.

Other aspects and example embodiments are provided in the drawings and the detailed description that follows.

### BRIEF DESCRIPTION OF THE FIGURES

For a more complete understanding of example embodiments of the present technology, reference is now made to the following descriptions taken in connection with the accompanying drawings in which:

FIGS. 1 to 7 are schematic cross-sectional views of cap arrangements for a bottle, in accordance with various example embodiments; and

FIGS. 8 and 9 are schematic front views of cap arrangements for a bottle, in accordance with further example embodiments.

The drawings referred to in this description are not to be understood as being drawn to scale except if specifically noted, and such drawings are only exemplary in nature.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details.

Reference in this specification to “one embodiment” or “an embodiment” means that a particular feature, structure, or characteristic described in connection with the embodiment is included in at least one embodiment of the present disclosure. The appearance of the phrase “in an embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure.

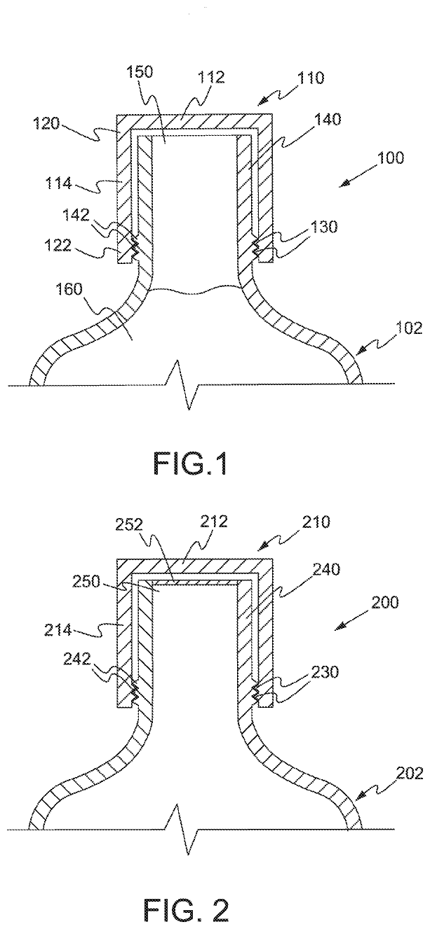

Referring now to the drawings, FIG. 1 is a schematic cross-sectional view of a cap arrangement 100 for a bottle 102, in accordance with an example embodiment. The cap arrangement 100 includes a cap 110 having a flat portion 112. The cap 110 further includes a hollow portion 114 having a first end 120 and an opposite second end 122. The hollow portion 114 extends vertically from a periphery of the flat portion 112. In an example, the cap 110 may be configured to have a circular configuration, i.e. the flat portion 112 may be configured to have a shape of a circular-flat structure and the hollow portion 114 may be configured to have a shape of a hollow cylindrical structure extending vertically from the periphery of the flat portion 112.

The cap 110 further includes one or more internal threads, such as internal threads 130, arranged on the second end 122, of the hollow portion 114, away from the first end 120. The cap arrangement 100 further includes a mouth portion 140 of the bottle 102. The mouth portion 140 includes one or more complementary external threads, such as external threads 142, arranged away from an opening 150 of the mouth portion 140 of the bottle 102. As shown, the one or more external threads 142 of the mouth portion 140 and the one or more internal threads 130 of the cap 110 allow threadable engagement between the cap 110 and the mouth portion 140 away from the opening 150 of the bottle 102. Also, this allows the cap 110 to form a leak tight seal over the mouth portion 140 of the bottle 102.

As shown in FIG. 1, the cap arrangement 100 for the bottle 102 includes a long mouth portion 140, and the threadable engagement between the cap 110 and the mouth portion 140 is arranged away from the opening 150 of the bottle 102. Therefore, the threadable engagement between the cap 110 and the mouth portion 140 does not come in contact with a mouth of a person drinking an edible liquid 160 contained in the bottle 102. It may be appreciated that the edible liquid 160 may include but not limited to water, juice, aerated drinks and so forth. Moreover, it may be appreciated that the cap arrangement 100 of the present disclosure may be used in conjunction with a bottle containing edible liquid, such as oil, sauce and so forth.

Referring now to the drawings, FIG. 2 is a schematic cross-sectional view of a cap arrangement 200 for a bottle 202, in accordance with another example embodiment. The cap arrangement 200 is substantially similar to the cap arrangement 100 of FIG. 1. For example, the cap arrangement 200 also includes a cap 210 having a flat portion 212 and a hollow portion 214 extending vertically from a periphery of the flat portion 212. The cap 210 also includes one or more internal threads, such as internal threads 230, arranged on the hollow portion 214. Further, the cap arrangement 200 includes a mouth portion 240, of the bottle 202, having one or more complementary external threads, such as external threads 242, arranged away from an opening 250 of the mouth portion 240 of the bottle 202. As shown, the external threads 242 of the mouth portion 240 and the internal threads 230 of the cap 210 allow threadable engagement between the cap 210 and the mouth portion 240 away from the opening 250 of the bottle 202. Additionally, the cap arrangement 200 further comprises a filter member 252 arranged on the mouth portion 240 for closing the opening 250 of the mouth portion 240.

Similar to the cap arrangement 100 of FIG. 1, the cap arrangement 200 of FIG. 2 includes a long mouth portion 240, and the threadable engagement between the cap 210 and the mouth portion 240 is arranged away from the opening 250 of the bottle 202. Therefore, the threadable engagement between the cap 210 and the mouth portion 240 does not come in contact with a mouth of a person drinking any edible liquid contained in the bottle 202. Additionally, the filter member 252 further enables in filtering the edible liquid contained in the bottle 202, when the person is drinking the edible liquid from the bottle 202.

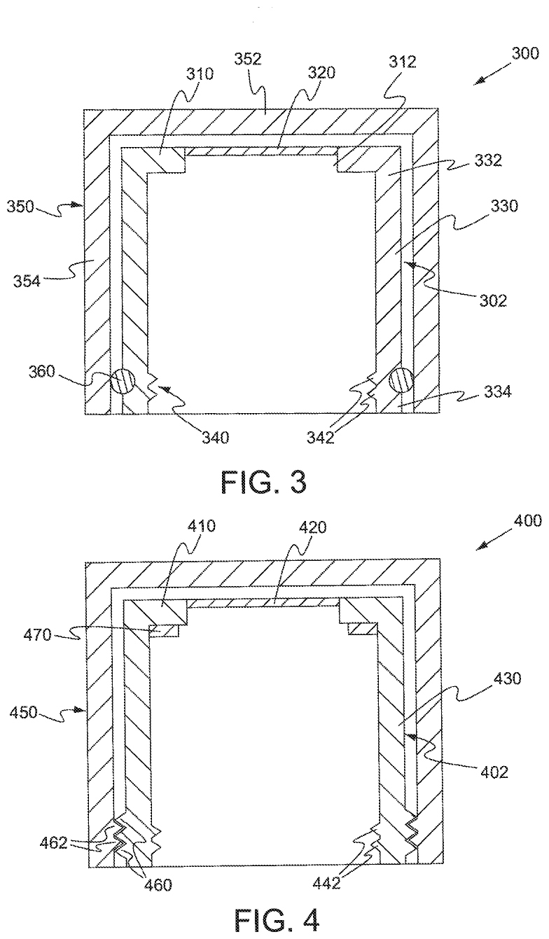

Referring now to FIG. 3, illustrated is a schematic cross-sectional view of a cap arrangement 300 for a bottle, in accordance with an example embodiment. It will be appreciated that the cap arrangement 300 may be used in conjunction with a bottle, i.e. a standard bottle in which a mouth portion is not long and threads arranged thereon may touch lips of a person drinking edible liquid from the bottle, for example a bottle used for selling packaged water. As shown, the cap arrangement 300 comprises a cap 302 having a flat portion 310 including a central opening 312. The cap 302 further comprises a filter member 320 arranged on the flat portion 310 for closing the central opening 312. The cap 302 also comprises a hollow portion 330 having a first end 332 and an opposite second end 334. The hollow portion 330 extends vertically from a periphery of the flat portion 310. The cap 302 further comprises a coupling mechanism 340 operable to engage the cap 302 to a mouth portion of the bottle to close an opening of the bottle. In an example, as shown in FIG. 3, the coupling mechanism 340 comprises one or more internal threads 342 arranged on the second end 334, of the hollow portion 330, away from the first end 332. The one or more internal threads 342 of the cap 302 are operable to engage with one or more complementary external threads arranged on the mouth portion the bottle.

The cap arrangement 300 also comprises a cap-cover 350 configured to enclose the cap 302 from outside. As shown, the cap-cover 350 comprises a flat portion 352 and a hollow portion 354 extending vertically from a periphery of the flat portion 352. Further, the flat and the hollow portions 352, 354 of the cap-cover 350 are configured to confirm to the flat and the hollow portions 310, 330 of the cap 302 for enclosing the cap 302 from outside. In simple words, the cap-cover 350 is configured to structurally conform to a shape of the cap 302, and configured to bigger than the cap 302 for enclosing the cap 302 from outside. The cap arrangement 300 further comprises an o-ring 360 externally arranged on the cap 302 to allow sealable coupling between the cap 302 and the cap-cover 350. In use, the filter member 320, arranged on the flat portion 310 of the cap 302, enables in filtering the edible liquid before being consumed by a person. This helps in removing unwanted particles (such as plastic particles) from the edible liquid that may generate from rubbing of the internal threads 342 of the cap 302 and external threads of the bottle.

Referring now to FIG. 4, illustrated is a schematic cross-sectional view of a cap arrangement 400 for a bottle, in accordance with an example embodiment. It will be appreciated that the cap arrangement 400 may be used in conjunction with a bottle, i.e. a standard bottle, as explained herein above in conjunction with FIG. 3. The cap arrangement 400 is substantially structurally and functionally similar to the cap arrangement 300 of FIG. 3. For example, the cap arrangement 400 comprises a cap 402 having a flat portion 410 arranged with a filter member 420. The cap 402 also comprises a hollow portion 430 extending vertically from a periphery of the flat portion 410. The cap 402 further comprises a coupling mechanism, i.e. one or more internal threads 442, arranged on the hollow portion 430. The cap arrangement 400 also comprises a cap-cover 450 configured to enclose the cap 402 from outside. However, the cap arrangement 400 comprises one or more external threads, such as external threads 460, arranged on the cap 402, and one or more internal threads, such as internal threads 462, arranged on the cap-cover 450 and operable to engage with the external threads 460 of the cap 402. Also, the cap arrangement 400 comprises a gasket 470 arranged underneath the flat portion 410 and around the filter member 420. The gasket 470 enables in sealing a mouth portion of the bottle, when the cap 402 comes in contact with the mouth portion of the bottle.

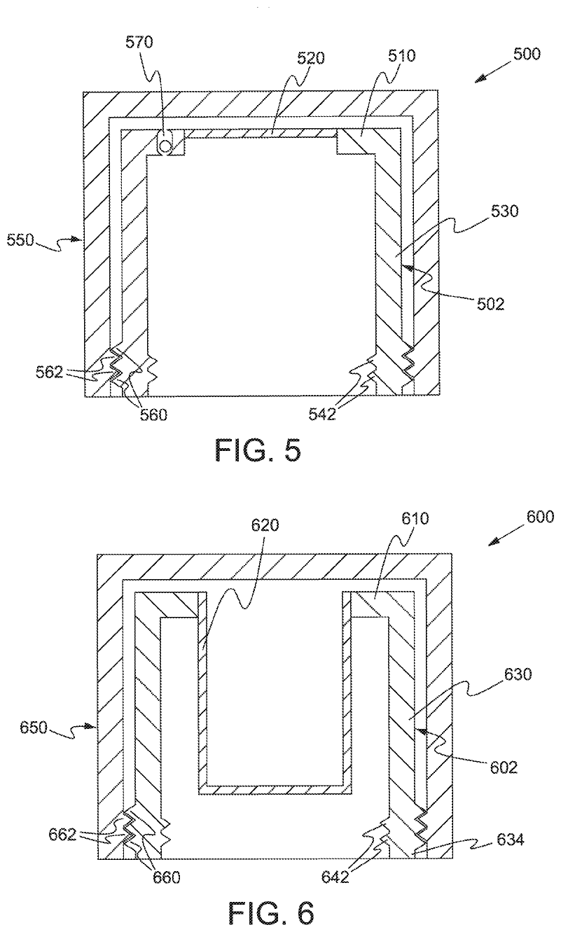

Referring now to FIG. 5, illustrated is a schematic cross-sectional view of a cap arrangement 500 for a bottle, such as a standard bottle, in accordance with an example embodiment. The cap arrangement 500 is substantially structurally and functionally similar to the cap arrangement 400 of FIG. 4. For example, the cap arrangement 500 comprises a cap 502 having a flat portion 510 arranged with a filter member 520. The cap 502 also comprises a hollow portion 530 extending vertically from a periphery of the flat portion 510. The cap 502 further comprises a coupling mechanism, i.e. one or more internal threads 542, arranged on the hollow portion 530. The cap arrangement 500 also comprises a cap-cover 550 configured to enclose the cap 502 from outside. The cap arrangement 500 also comprises external threads 560 arranged on the cap 502 and internal threads 562, arranged on the cap-cover 550, and operable to engage with the external threads 560 of the cap 502. However, the cap arrangement 500 further comprises a check valve 570 arranged on the flat portion 510 of the cap 502. The check valve 570 is integrated into the cap 502 to allow air to flow into a bottle arranged with the cap arrangement 500. Specifically, the check valve 570 allows air to flow into the bottle after edible liquid therefrom has been squeezed out for drinking. In an example, the check valve 570 may be made using injection molding technology with a size of 0.1 mm-3 mm. Further, the check valve 570 may be made of plastic or metal.

Referring now to FIG. 6, illustrated is a schematic cross-sectional view of a cap arrangement 600 for a bottle, such as a standard bottle, in accordance with an example embodiment. The cap arrangement 600 is substantially structurally and functionally similar to the cap arrangement 400 of FIG. 4. For example, the cap arrangement 600 comprises a cap 602 having a flat portion 610. The cap 602 also comprises a hollow portion 630 extending vertically from a periphery of the flat portion 610. The cap 602 further comprises a coupling mechanism, i.e. one or more internal threads 642, arranged on the hollow portion 630. The cap arrangement 600 also comprises a cap-cover 650 configured to enclose the cap 602 from outside. The cap arrangement 600 also comprises external threads 660 arranged on the cap 602 and internal threads 662, arranged on the cap-cover 650, and operable to engage with the external threads 660 of the cap 602. The cap arrangement 600 also comprises a filter member 620 arranged on the flat portion 610. However, the filter member 620 extends from the flat portion 610 towards a second end 634 of the hollow portion 630. It will be appreciated that the filter member 620 is configured to have a U-shaped structure to have an overall increased size in area to allow increased flow of edible liquid from a bottle arranged with the cap arrangement 600. Further, the bottle can be squeezed to increase the flow of the edible liquid therefrom.

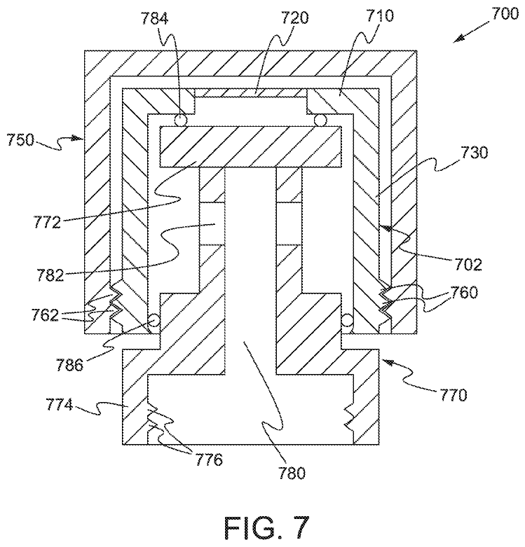

Referring now to FIG. 7, illustrated is a schematic cross-sectional view of a cap arrangement 700 for a bottle, in accordance with an example embodiment. It will be appreciated that the cap arrangement 700 depicted herein may be a cap arrangement of a sport bottle having a push arrangement for drinking an edible liquid from the sport bottle. The cap arrangement 700 is structurally and functionally similar to the cap arrangement 400 of FIG. 4. For example, the cap arrangement 700 comprises a cap 702 having a flat portion 710 arranged with a filter member 720. The cap 702 also comprises a hollow portion 730 extending vertically from a periphery of the flat portion 710. The cap arrangement 700 also comprises a cap-cover 750 configured to enclose the cap 702 from outside. The cap arrangement 700 comprises external threads 760 arranged on the cap 702 and internal threads 762, arranged on the cap-cover 750, operable to engage with the external threads 760 of the cap 702. Moreover, the cap arrangement 700 comprises a cap-support 770 having a closed top portion 772 configured to be moveably coupled to the cap 702, and an open bottom portion 774 integral with the closed top portion 772. The open bottom portion 774 comprises a coupling mechanism operable to engage the cap 702 to a mouth portion of the sports bottle. Specifically, the coupling mechanism comprises one or more internal threads, such as internal threads 776 arranged on the open bottom portion 774. The internal threads 776 of the cap-support 770 are operable to engage with one or more complementary external threads arranged on the mouth portion of the bottle.

As shown in FIG. 7, the cap-support 770 further comprises a central channel 780 extending from the closed top portion 772 to the open bottom portion 774. The cap-support 770 also comprises a lateral opening 782 arranged on the closed top portion 772. The lateral opening 782 is fluidically coupled to the central channel 780. The cap arrangement 700 further comprises a pair of o-rings 784 and 786 arranged between the cap 702 and the closed top portion 772 to allow sealable coupling between the cap 702 and the cap-support 770. The pair of o-rings 784, 786 enable in achieving a leak-proof seal for a bottle having the cap arrangement 700. In use, the cap 702 is operable to move with respect to the cap-support 770, thereby allowing an edible fluid to flow through the central channel 780 towards the lateral opening 782 and finally out of the filter member 720 for being consumed.

The cap arrangements 100-700 of FIGS. 1 to 7, for example the cap, the cap-cover, the filter member, the cap-support, the gasket and the o-rings are made from a food grade material. In an example, the cap arrangements 100-700 may be made of a food grade plastic material, such as Nylon, Polyethylene terephthalate (PET), Polypropylene (PP), Polyethylene (PE), and so forth. Alternatively, the cap arrangements 100-700 may be made of a food grade metal, such as stainless-steel SS-304 or SS-316, and so forth. Moreover, the cap arrangements 100-700 may be made of both plastic material and metal. For example, few components of the cap arrangements may be made of plastic material, and remaining components of the cap arrangements may be made of metal. Furthermore, the filter members of the cap arrangements 300-700 may comprise pores having a size in a range of 5 to 250 μm (micrometers).

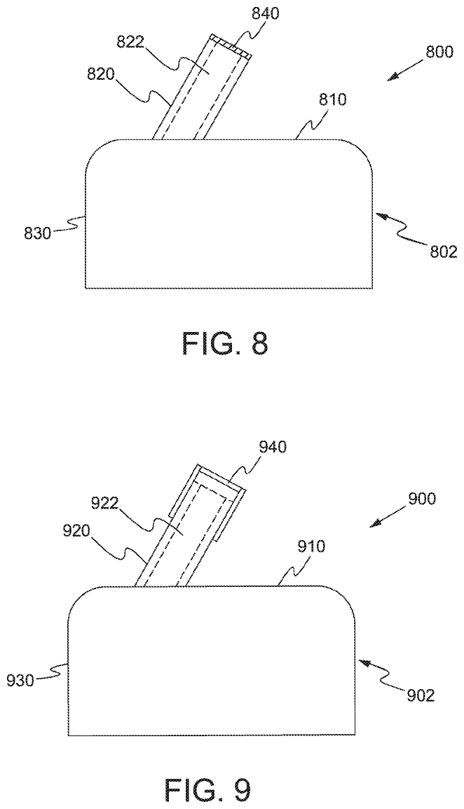

Referring now to FIG. 8, illustrated is a schematic front view of a cap arrangement 800 for a bottle, in accordance with further example embodiments. It will be appreciated that the cap arrangement 800 may be used in conjunction with a bottle, having a wider mouth opening, unlike a typical bottle used for selling packaged water. The cap arrangement 800 comprises a cap 802 having a flat portion 810. The cap arrangement 800 also comprises a spout 820 arranged on the flat portion 810. The spout 820 comprises an opening 822 and configured to attain an open position (as shown in FIG. 8) and a close position (not shown) with respect to the flat portion 810. In an example, the spout 820 is pivotally arranged on the flat portion 810 to attain the open and the close positions. The cap 802 also comprises a hollow portion 830 extending vertically from a periphery of the flat portion 810. The cap 802 further comprises one or more internal threads (not shown) arranged on the hollow portion 830. The internal threads of the cap 802 are operable to engage with one or more complementary external threads arranged on a mouth portion of the bottle. The cap arrangement 800 also comprises a filter member 840 arranged on the spout 820, particularly for closing the opening 822 of the spout 820. In the present embodiment, the filter member 840 is arranged fixedly on the spout 820.

Referring now to FIG. 9, illustrated is a schematic front view of a cap arrangement 900 for a bottle, such as a bottle having a wider mouth opening and explained herein above with FIG. 8, in accordance with further example embodiments. The cap arrangement 900 is substantially structurally and functionally similar to the cap arrangement 800 of FIG. 8. For example, the cap arrangement 900 comprises a cap 902 having a flat portion 910 arranged with a spout 920. The cap 902 also comprises a hollow portion 930 extending vertically from a periphery of the flat portion 910. The cap 902 further comprises one or more internal threads (not shown) arranged on the hollow portion 930. The cap arrangement 900 also comprises a filter member 940 arranged on the spout 920 for closing an opening 922 thereof. However, in the present embodiment, the filter member 940 is detachably arranged on the spout 920. For example, the filter member 940 may be configured to be a sleeve like structure operable to be slidably received by an end portion of the spout 920 for closing the opening 922 thereof.

The cap arrangements 800, 900 of FIGS. 8 and 9, particularly, the caps 802, 902 and the filter members 840, 940 thereof are made from a food grade material. In an example, the caps 802, 902 and the filter members 840, 940 may be made of a food grade plastic material, such as Nylon, Polyethylene terephthalate (PET), Polypropylene (PP), Polyethylene (PE), and so forth. Alternatively, the caps 802, 902 and the filter members 840, 940 may be made of a food grade metal, such as stainless-steel SS-304 or SS-316, and so forth. Moreover, the cap arrangements 800-900 may be made of both plastic material and metal. For example, few components of the cap arrangements may be made of plastic material, and remaining components of the cap arrangements may be made of metal. Furthermore, the filter members 840, 940 may comprise pours having a size in a range of 5 to 250 micrometers. In use, the spouts 820, 920 are operable to attain the open position with the filter members 840, 940 arranged thereon to allow an edible fluid contained in a bottle to be filtered prior to consumption thereof.

Embodiments of the present disclosure substantially eliminate or at least partially address the aforementioned problems in the background, and provide an improved cap arrangement for a bottle. The cap arrangement of the present disclosure may be used in conjunction with Tetrapak® pouches or cartons. The cap arrangements of the present disclosure may be disposable and/or reusable in nature. Further, the reusable cap arrangements may be easily cleaned with the help of water and detergents. Also, such reusable cap arrangements may include a box for the storage thereof when not in use. The cap arrangement of the present disclosure is configured to have a threadable arrangement between a cap and a mouth portion of the bottle in a manner such that a person's mouth avoids contact with such threadable arrangement, and thereby avoiding consumption of plastic particles that may be generated by the threadable arrangement. Further, the cap arrangement of the present disclosure includes a filter member configured in such a manner that the filter member filters an edible liquid (contained in a bottle) prior to consumption of the edible liquid from the bottle. Therefore, the cap arrangements of the present disclosure are designed to mitigate medical problems that may be caused due to consumption of plastic particles (generally found in the conventional bottles).

The embodiments illustrated and described herein as well as embodiments not specifically described herein but within the scope of aspects of the invention constitute exemplary cap arrangement for a bottle.

The benefits and advantages described above may relate to one embodiment or may relate to several embodiments. The embodiments are not limited to those that solve any or all of the stated problems or those that have any or all of the stated benefits and advantages.

The above description is given by way of example only and various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from the spirit or scope of this specification.

What is claimed is:

1. A cap arrangement for a bottle, the cap arrangement comprising:
a cap comprising:
a flat portion;
a hollow portion having a first end and an opposite second end, the hollow portion extending vertically from a periphery of the flat portion; and
one or more internal threads arranged on the second end, of the hollow portion, away from the first end; and
a mouth portion of the bottle, the mouth portion comprising one or more complementary external threads arranged away from an opening of the mouth portion of the bottle, wherein the one or more external threads and the one or more internal threads allow threadable engagement between the cap and the mouth portion away from the opening of the bottle.

2. The cap arrangement as claimed in claim 1, further comprising a filter member arranged on the mouth portion for closing the opening of the mouth portion.

3. A cap arrangement for a bottle, the cap arrangement comprising:
a cap having:
a flat portion having a central opening;
a filter member arranged on the flat portion for closing the central opening;
a hollow portion having a first end and an opposite second end, the hollow portion extends vertically from a periphery of the flat portion; and
a coupling mechanism operable to engage the cap to a mouth portion of the bottle to close an opening of the bottle; and
a cap-cover configured to enclose the cap from outside.

4. The cap arrangement as claimed in claim 3, wherein the cap and the cap-cover are made from a food grade material.

5. The cap arrangement as claimed in claim 3, wherein the filter member comprises pours having a size in a range of 5 to 250 micrometers.

6. The cap arrangement as claimed in claim 3, wherein the coupling mechanism comprises one or more internal threads arranged on the second end, of the hollow portion, away from the first end, and wherein the one or more internal threads of the cap is operable to engage with one or more complementary external threads arranged on the mouth portion of the bottle.

7. The cap arrangement as claimed in claim 3, wherein the cap-cover comprises:
a flat portion; and
a hollow portion extending vertically from a periphery of the flat portion,
wherein the flat and hollow portions of the cap-cover are configured to confirm to the flat and hollow portions of the cap for enclosing the cap from outside.

8. The cap arrangement as claimed in claim 3, further comprising an o-ring externally arranged on the cap to allow a sealable coupling between the cap and the cap-cover.

9. The cap arrangement as claimed in claim 3, further comprising:
one or more external threads arranged on the cap; and
one or more internal threads arranged on the cap-cover operable to engage with the one or more external threads of the cap.

10. The cap arrangement as claimed in claim 3, further comprising a gasket arranged underneath the flat portion and around the filter member, wherein the gasket enables in sealing the mouth portion of the bottle with the cap.

11. The cap arrangement as claimed in claim 3, further comprising a cap-support comprising:
a closed top portion configured to be moveably coupled to the cap; and
an open bottom portion integral with the closed top portion, the open bottom portion comprises the coupling mechanism operable to engage the cap to the mouth portion of the bottle.

12. The cap arrangement as claimed in claim 11, wherein the coupling mechanism comprises one or more internal threads arranged on the open bottom portion, the one or more internal threads of the cap-support is operable to engage with one or more complementary external threads arranged on the mouth portion of the bottle.

13. The cap arrangement as claimed in claim 11, wherein the cap-support further comprises:
a central channel extending from the closed top portion to the open bottom portion; and
a lateral opening arranged on the closed top portion, the lateral opening fluidically coupled to the central channel.

14. The cap arrangement as claimed in claim 11, further comprising a pair of o-rings arranged between the cap and the closed top portion to allow a sealable coupling between the cap and the cap-support.

15. The cap arrangement as claimed in claim 3, further comprising a check valve arranged on the flat portion of the cap.

16. The cap arrangement as claimed in claim 3, wherein the filter member extends from the flat portion towards the second end of the hollow portion.

17. A cap arrangement for a bottle, the cap arrangement comprising:
a cap comprising:
a flat portion;
a spout arranged on the flat portion, the spout comprises an opening and configured to attain an open position and a close position with respect to the flat portion;
a hollow portion extending vertically from a periphery of the flat portion; and
one or more internal threads arranged on the hollow portion,
wherein the one or more internal threads of the cap is operable to engage with one or more complementary external threads arranged on a mouth portion of the bottle; and
a filter member arranged on the spout.

18. The cap arrangement as claimed in claim 17, wherein the filter member is detachably arranged on the spout.

19. The cap arrangement as claimed in claim 17, wherein the filter member is arranged fixedly on the spout.

20. The cap arrangement as claimed in claim 17, wherein the cap and the filter member are made from a food grade material.
